(19) United States
(12) Patent Application Publication
(10) Pub. No.: US 2009/0025352 A1
(43) Pub. Date: Jan. 29, 2009

(54) Apparatus and Method for Handling a Cutting Device

(76) Inventor: Clinton J. Angelle, Breaux Bridge, LA (US)

Correspondence Address: LONGMAN RUSSO;A PROFESSIONAL LAW CORPORATION, P.O. DRAWER 3408, LAFAYETTE, LA, 70502-3408, US

(21) Appl. No.: 12/196,934

(22) Filed: Aug. 22, 2008

Related U.S. Application Data
(63) Continuation-in-part of application No. 11/710,887, filed on Feb. 26, 2007.

(51) Int. Cl. A01D 34/00

(52) U.S. Cl. 56/16.7; 83/13

(57) ABSTRACT

An apparatus for holding a vegetation cutting device. The cutting device includes a cutting head, a handle or shaft attached to the cutting head, and a power unit attached to the handle and supplying power to the cutting head. The apparatus comprises a clamp member having disposed therein the device handle or shaft, and wherein the clamp member includes a pole support member. The apparatus further comprises a pole support operatively associated with the pole support member, a knob and stem for selectively attaching the clamp member to the pole support, and an angle adjustment plate and wheel assembly operatively attached to the clamp member via an offset plate for rotatably moving the cutting head. The apparatus also includes apertures for orienting the angle adjustment plate to a proper orientation with respect to the wheel assembly, and a tab operatively attached to the pole support for rotating the pole support to align with the apertures.

### CROSS-REFERENCE TO RELATED APPLICATIONS

This application is a continuation-in-part of U.S. patent application Ser. No. 11/710,887, filed Feb. 26, 2007.

### FIELD OF THE INVENTION

The present invention relates to a device used in the cutting of vegetation. More specifically, but not by way of limitation, the present invention relates to an apparatus for handling a vegetation cutting device.

### BACKGROUND OF THE INVENTION

Many types of prior art vegetation cutting devices have been developed. Vegetation cutting devices are referred to as weed and grass trimmers. Weed and grass trimmers are commercially available from Stihl Incorporated under the name FS 80 Trimmer. Generally, the trimmers have a cutting head section connected to a handle or shaft, which in turn is connected to a power section. The cutting head is generally a circular center segment having at least one cutting arm, and wherein the cutting arm may be a flexible polymeric member having properties similar to fishing line.

Regardless of the exact type of trimmer used, operators have a difficult problem handling the cutting heads. While the prior art trimmers are useful and convenient, the design is ergonomically unfriendly. Prior art designs make it difficult to maneuver the cutting head in the various positions required when cutting grass, shrubbery, vegetation, sidewalks, etc. Prior art designs make it particularly difficult to maneuver the cutting head after prolonged use.

Therefore, there is a need for an apparatus for handling a vegetation cutting device. There is also a need for a vegetation cutting device. Further, there is a need for an apparatus that will allow for easy maneuvering and steering during operation. Additionally, there is a need for a method of cutting vegetation that allows for an operator to easily change the orientation of the cutting head to suit the operator's specific circumstances. There is also a need for a vegetation cutting device that is ergonomically engineered to allow ease of use and control by the operator. These needs, as well as many others, will be met by the following disclosure.

### SUMMARY OF THE INVENTION

An apparatus for handling a vegetation cutting device is disclosed. The cutting device includes a cutting head, a handle or shaft attached to the cutting head, and a power unit attached to the handle and supplying power to the cutting head. The apparatus comprises a clamp member having disposed therein the device handle, and wherein the clamp member includes a cylinder member. The apparatus further comprises a pole support operatively associated with the cylinder member, means for selectively attaching the clamp member to the pole support, and an angle adjustment plate operatively attached to the pole support. The apparatus further comprises a caster means, operatively attached to the pole support, for rotatably moving the cutting head, means for orienting the angle adjustment plate to a proper orientation with respect to the wheel member, and a tab member operatively attached to the pole support for rotating the pole support to align with the orienting means.

In one preferred embodiment, the caster means comprises a bracket extending from the angle adjustment plate and a wheel operatively attached to the bracket. Also, in the most preferred embodiment, the wheel includes a first elliptical surface extending to a cylindrical surface, which in turn extends to a second elliptical surface. Additionally, in the preferred embodiment, the cylindrical surface has a width providing a contact surface so that as the cylindrical surface contacts the ground surface, the rolling friction resistance is significantly reduced.

The clamp member, in one preferred embodiment, includes an indented portion configured to clasp the handle or shaft of the cutting device. The indented portion may be at an angle between 20 degrees and 50 degrees relative to the pole support. In the preferred embodiment, the orienting means includes a series of apertures in the angle adjustment plate. Additionally, the clamp means may include dial means for rotating the handle so that the angle of the handle is adjustable, and wherein the angle of the handle is adjustable relative to the pole support. In the preferred embodiment, the dial means includes a first plate having serrated teeth disposed about a center and a second plate having reciprocal serrated teeth disposed about a center, and wherein the first plate and the second plate are configured to engage.

In one preferred embodiment, the attaching means includes a knob with a stem and wherein the stem is configured to engage the pole support in order to slidably adjust the clamp member relative to the pole support. Additionally, the apparatus may further comprise a locking means for locking the tab member in place relative to the angle adjustment plate. The locking means may comprise a pin configured to engage the apertures in the angle adjustment plate.

A method for cutting vegetation is also disclosed. The method comprises providing a cutting device, with the device comprising a cutting head, a handle or shaft attached to the cutting head, a power unit attached to the handle and supplying power to the cutting head, a clamp member having disposed therein the device handle, with the clamp including a cylinder member, a pole operatively associated with the cylinder member; and means for selectively attaching the clamp to the pole. The device further comprises an angle adjustment plate operatively attached to the pole, with the angle adjustment plate having a bracket extending therefrom, a wheel operatively attached to the bracket, a series of apertures for orienting the angle adjustment plate to a proper orientation, and a tab operatively attached to the pole for rotating the pole in order to select the aperture.

The method further comprises adjusting the height of the clamp relative to the pole so that the height of the cutting head is changed and energizing the power unit. The method further includes rotating the cutting head and cutting the vegetation with the cutting head. In the preferred embodiment, the method further includes terminating the power to the power unit, and adjusting the orientation of the wheel, wherein the orientation of the wheel is adjusted by engaging the tab with a selected aperture so that the direction of the wheel is adjusted.

In another preferred embodiment, a device for cutting vegetation is also disclosed. In this embodiment, the apparatus comprises a cutting head, a handle or shaft attached to the cutting head, and a power unit attached to the handle and supplying power to the cutting head. The apparatus further comprises a clamp member having disposed therein the device handle, with the clamp member including a cylinder member and dial means for rotating the handle in order to adjust the handle's angle, a pole support operatively associated with the cylinder member, and means for selectively attaching the clamp member to the pole support. In this embodiment, the apparatus further comprises an angle adjustment plate operatively attached to the pole support, with the angle adjustment plate having a bracket extending therefrom, a wheel member operatively attached to the bracket, and a series of apertures in the angle adjustment plate. A pole support axis intersects the mid-point of the wheel member. The apparatus further includes a tab member operatively attached to the pole support for rotating the pole support into engagement with a selected aperture in order to orient the wheel member to a desired position.

In an alternative embodiment of the present invention an apparatus for attachment to a weed and grass trimmer is provided. The apparatus includes a clamp member. The clamp member has a pole-support member and a clamp assembly. The clamp assembly contains two matching V-shaped halves. Each of the V-shaped halves has a proximal end and a distal end. The distal ends of the V-shaped halves are pivotally connected together. The clamp assembly contains an indented portion for engaging a shaft of the trimmer. The apparatus also includes a pole support. The pole support has a proximal end and a distal end. The pole-support is operatively associated with the pole-support member. A portion of the pole support is encased within an elongated integral portion of the pole support member. The apparatus also includes an attaching assembly associated with the clamp member. The attaching assembly includes an adjustable knob and connected stem. The stem is configured to engage the pole support in order to slidably adjust the pole support relative to the clamp member.

The alternative embodiment of the apparatus has an offset plate. The offset plate includes a top surface, a bottom surface, and a side surface or interconnecting side surfaces. The offset plate has a first end and a second end. The distal end of the pole support is affixed to the top surface of the offset plate at the first end thereof. The alternative apparatus also has an angle adjustment plate operatively attached to the offset plate at the second end thereof. The angle adjustment plate has a bracket extending therefrom. A wheel member is operatively attached to the bracket. The wheel member has a first elongated elliptical surface extending to a cylindrical surface. The cylindrical surface extends to a second elongated elliptical surface. The cylindrical surface contacts the surface of the ground in order to reduce the friction of the wheel member to the ground surface. The wheel member has a center axis that is in alignment with the center axis of the shaft of the trimmer.

The alternative apparatus also includes means for orienting the angle adjustment plate to a proper orientation with respect to the wheel member. The means for orienting include a series of apertures in the angle adjustment plate. A tab member is operatively attached to the pole support for rotating the pole support to align with the orienting means. The alternative embodiment also has locking means for locking the tab member in place relative to the angle adjustment plate. The locking means comprise a pin directly affixed to the tab member. The pin is configured to engage a selected aperture of the series of apertures in the angle adjustment plate such that the wheel is prevented from swiveling with respect to the tab member but not prevented from rolling.

In the alternative apparatus, the indented portion of the clamp assembly may be at an angle between 30 degrees and 50 degrees relative to the pole support.

The offset plate of the alternative apparatus may be substantially oval-shaped. The offset plate may also include a threaded hole for threadedly receiving a bolt. The bolt operatively associates the offset plate to the angle adjustment plate. The offset plate may also include an extension protruding from the bottom surface thereof. The extension contains a threaded hole that is in alignment with the threaded hole in the offset plate. The threaded holes of the extension and offset plate threadedly receive the bolt. The bolt may further be secured to the extension (and thereby to the offset plate) by a locking nut.

The alternative apparatus may also be comprised of a clamp member. The clamp member may include a pole-support member. The clamp member may also have a dial means for rotating the shaft of the weed and grass trimmer when the shaft is engaged with the clamp member so that the angle of the shaft is adjustable. The clamp member may also include a clamp assembly having two matching V-shaped halves. Each of the halves contains a proximal end and a distal end. The distal ends of the halves are pivotally connected about one another. The clamp assembly contains an indented portion for engaging the shaft of the trimmer. The pole support has a proximal end and a distal end. The pole support is operatively associated with the pole-support member. A portion of the pole support is encased within an elongated integral portion of the pole-support member.

The further alternative apparatus includes an attaching assembly. The attaching assembly is associated with the clamp member. The attaching assembly includes an adjustable knob and connected stem. The stem is configured to engage the pole support in order to slidably adjust the pole support relative to the clamp member. The apparatus may also include an offset plate. The offset plate has a top surface, a bottom surface, and a side surface or interconnecting side surfaces. The offset plate also has a first end and a second end. The distal end of the pole support is affixed to the top surface of the offset plate at the first end thereof. An angle adjustment plate is operatively attached to the offset plate at the second end thereof. The angle adjustment plate has a bracket extending therefrom. A caster means is provided, which includes a wheel. The wheel is operatively attached to the bracket of the angle adjustment plate for rotatably moving the cutting head of the trimmer. The wheel includes a first elongated elliptical surface extending to a cylindrical surface. The cylindrical surface extends to a second elongated elliptical surface. The wheel has a center axis that is in alignment with a center axis of the shaft of the trimmer.

The further alternative apparatus includes a means for orienting the angle adjustment plate to a proper orientation with respect to the caster means. The means for orienting includes a series of apertures in the angle adjustment plate. A tab member is operatively attached to the pole support for rotating the pole support to align with the orienting means. The apparatus also includes a locking means for locking the tab member in place relative to the angle adjustment plate. The locking means comprise a pin directly affixed to the tab member. The pin is configured to engage a selected aperture of the series of apertures in the angle adjustment plate such that the wheel is prevented from swiveling with respect to the tab member but not prevented from rolling.

In the further alternative embodiment, the dial means may include a first plate having serrated teeth disposed about a center of the first plate and a second plate having reciprocal serrated teeth disposed about a center of the second plate.

The present invention is also drawn to a method for cutting vegetation. The method includes providing a cutting device. The device comprises a cutting head, a shaft attached to the cutting head, and a power unit attached to the shaft that supplies power to the cutting head. The device includes a clamp in which the shaft of the device is disposed therein. The clamp includes a pole-support member and a clamp assembly. The clamp assembly has two matching V-shaped halves. Each of the halves includes a proximal end and a distal end. The distal ends of the halves are pivotally connected together. The clamp assembly contains an indented portion for engaging the shaft of the cutting device. The clamp includes a pole having a proximal end and a distal end. The pole is operatively associated with the pole-support member. The pole-support member includes an elongated integral portion that encases a portion of the pole. The clamp has an attaching assembly associated with the pole-support member. The attaching assembly includes an adjustable knob and connected stem. The stem is configured to engage the pole in order to slidably adjust the pole relative to the pole-support member. The clamp also contains an offset plate having a top surface, a bottom surface, and a side surface or interconnecting side surfaces. The offset plate has a first end and a second end. The distal end of the pole is affixed to the top surface of the offset plate at the second end thereof. The clamp includes an angle adjustment plate that is operatively attached to the offset plate at the second end thereof. The angle adjustment plate has a bracket extending therefrom. The clamp has a wheel operatively attached to the bracket. The wheel has a center axis that is in alignment with a center axis of the shaft of the cutting device. The clamp includes a series of apertures for orienting the angle adjustment plate to a proper orientation. A tab is also provided that is operatively attached to the pole for rotating the pole for selecting the aperture. The clamp includes a locking means for locking the tab in place relative to the angle adjustment plate. The locking means comprise a pin directly affixed to the tab. The pin is configured to engage a selected aperture of the series of apertures in the angle adjustment plate such that the wheel is prevented from swiveling with respect to the tab but not prevent from rolling.

The method includes the step of adjusting the height of the clamp relative to the pole so that the height of the cutting head is changed. The power unit is energized. The cutting head is rotated. Vegetation is cut with the cutting head of the trimmer.

The method may also include the steps of terminating power to the power unit thereby de-energizing the power unit, and adjusting the orientation of the wheel. The orientation of the wheel is adjusted by engaging the tab with a selected aperture so that the direction of the wheel is adjusted.

An advantage of the present invention is the control and ease of operation that the operator exercises over the trimmer. Another advantage of the present invention is that the design allows for greater operator control of the cutting head to meet individual needs. Another advantage is that due to the design, the cutting blade does not gouge the ground, which in turn leads to greater control. Yet another advantage is that the ergonomically engineered design allows for minimum strain and stress to the user's body, including the back, arms and legs. In particular, with the present apparatus, stress and strain to the operator's back is significantly reduced. Still yet another advantage is that the operator's wrist controls most of the operation.

Yet another advantage is that the disclosed apparatus will work with all trimmers. Yet another advantage is that the cutting line can still be extended in the same manner that most trimmers employ i.e. tapping on the line hub on the bottom of the cutting head. Still yet another advantage is that the apparatus of the present disclosure does not limit the functionality of the trimmer. In other words, the operator uses the trimmer in the manner that the trimmer was originally designed. Another advantage is the apparatus allows for multiple height positions of the cutting head.

A feature of the present invention is the wheel design. For instance, the wheel has a wide width thereby minimizing friction as the wheel travels along the ground level. The width of the wheel is designed to lessen the pressure of the wheel traveling over various surfaces including but not limited to grass, concrete, gravel, sand, etc. Another feature of the present invention is that in the most preferred embodiment, the wheel has three surfaces including two (2) elliptical surfaces and one (1) cylindrical surface. Yet another feature is that the wheel will not hinder or compromise normal operation of the trimmer.

Another feature is that the orientation of the cutting head relative to the wheel direction is adjusted by the operator selecting the appropriate aperture in the angle adjustment plate. Changing wheel direction is a simple and intuitive step. Yet another feature is that the tab rotates the pole support, which in turn re-directs the handle of the cutting device which sets the cutting head in the correct orientation for the operator.

Still yet another feature is that with the wheel, lateral ground movement of the cutting head is facilitated by the rotating blade creating a forward force by the action of the rotating blade against the vegetation. In other words, the rotating blade acts against the vegetation, which in turn creates a force that tends to pull the wheel and cutting head forward. Hence, with the addition of the wheel, the trimmer becomes somewhat self-propelled. Yet another feature is that the cutting head can be rotated 90 degrees in order for the trimmer to function as an edger, such as seen in FIG. 6. Still yet another feature is the dial member that is used to adjust the angle of the handle.

A further feature is the offset plate positions the caster means or wheel in alignment with the shaft of the trimmer. Such alignment causes a more balanced handling system such that the trimmer is more easily manipulated.

### BRIEF DESCRIPTION OF THE DRAWINGS

FIG. 1 is a perspective view of the apparatus of the present disclosure.

FIG. 2 is an exploded view of the apparatus seen in FIG. 1.

FIG. 3 is a side view of the apparatus seen in FIG. 1.

FIG. 4 is a partial front view of apparatus seen in FIG. 3 taken along line 4-4.

FIG. 5 is a partial front view of the apparatus seen in FIG. 3 taken along line 5-5.

FIG. 6 is a perspective view of the apparatus seen in FIG. 1, wherein the cutting head has been tilted to a vertical position.

FIG. 7 is a top perspective view of the apparatus seen in FIG. 6.

FIG. 8 is a perspective side view of the apparatus seen in FIG. 1 showing the clamp member in different positions.

FIG. 9 is a perspective side view of the apparatus seen in FIG. 1 illustrating the wheel being rotated in different positions by the dial means.

FIG. 10 is a perspective view of an alternative embodiment of the present invention.

FIG. 11 is a front view of the alternative embodiment of the present invention shown in FIG. 10.

### DETAILED DESCRIPTION OF PREFERRED EMBODIMENTS

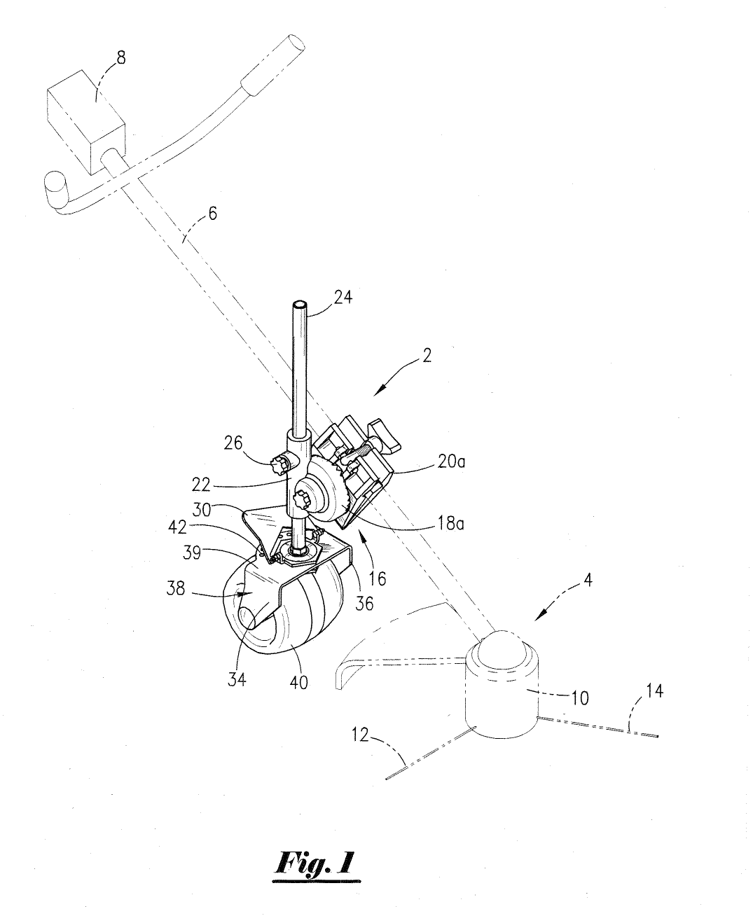

Referring now to FIG. 1, a perspective view of the apparatus 2 of the present disclosure will now be described. The apparatus 2 is clasping a cutting device, wherein the cutting device includes a cutting head 4, a handle or shaft 6 connected to the cutting head 4, and a power unit 8 for supplying power to the cutting head 4, and wherein the handle 6 is connected to the power unit 8. The power unit 8 may include a connection to an alternating current circuit, direct current circuit, or a combustible fuel engine means. Cutting devices are commercially available, as noted earlier. The cutting head 4 contains a shield S.

The cutting head 4 has a center hub 10 that has extending therefrom blades 12, 14. The blades are generally constructed of a flexible, polymeric material in the nature of fishing line. The hub 10 is rotated, generally by electrical means or combustible fuel engine means generated via the power unit 8, thereby causing the blades to rotate and cut the vegetation as well understood by those of ordinary skill in the art. Rigid blades may be used in place of the flexible blades. In the most preferred embodiment, a combustible fuel engine means is used as the power unit 8.

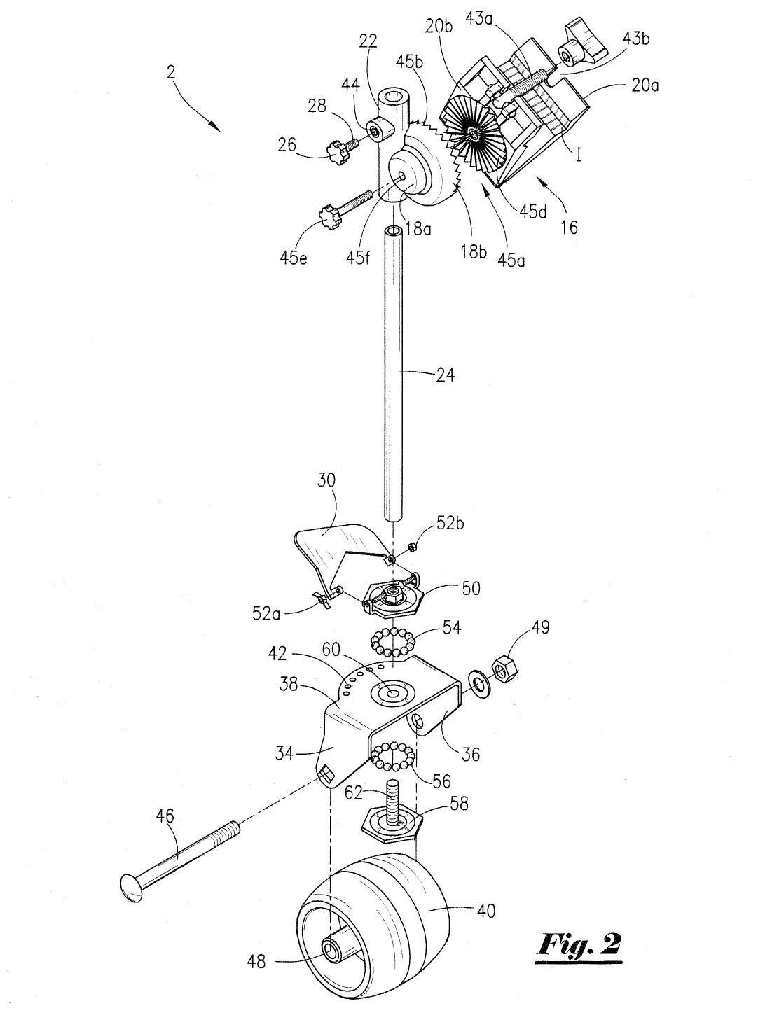

The apparatus 2 includes a clamp member 16, and wherein the clamp member 16 has disposed therein the handle 6. The clamp member 16 has two segments, generally seen at 18a, 20a. The clamp member 16 also includes the cylinder member 22. A pole support 24 is disposed within the cylinder member 22. The clamp member 16 contains means for selectively attaching the clamp member 16 to the pole support 24; more specifically, the attaching means includes knob 26 with a stem 28 (seen in FIG. 2), and wherein the stem 28 is configured to engage the pole support 24 in order to slidably adjust the clamp member 16 relative to the pole support 24.

FIG. 1 also depicts the tab member 30 that is operatively attached to the pole support 24 for rotating the pole support 24 in order to properly orient the cutting head 4. FIG. 1 also depicts the angle adjustment plate, seen generally at 38. The angle adjustment plate 38 includes the two sides 34, 36 as well as the top surface 39. The angle adjustment plate 38 contains the means for orienting the angle adjustment plate 38 to a proper orientation with respect to the wheel 40. The orienting means includes a plurality of apertures, seen generally at 42. As will be explained later in the disclosure, the tab member 30 will cooperate with the apertures 42 in order to adjust the direction of the wheel 40 properly relative to the cutting head 4. The angle adjustment plate 38 also serves to provide an axle wheel frame. The wheel 40 and bracket sides 34, 36 are sometimes referred to as caster means.

Referring now to FIG. 2, an exploded view of the apparatus 2 seen in FIG. 1 will now be described. It should be noted that like numbers appearing in the various figures refer to like components. The clamp member 16 is shown in the first segment 18a and in the second segment 20a. The indented portion I of the clamp 16 is also shown. A latch means for latching the first handle grasping halves together is shown generally at 43a. The latch means 43a is a shank with thread means and head with cooperating thread means, wherein the head is configured to engage with the groove 43b. The knob 26 and stem 28 are shown, and wherein the stem 28 will cooperate to threadedly engage the opening 44 in order to lock the pole support 24 in place relative to cylinder member 22. FIG. 2 also shows dial means 45a for rotating the handle 6 so that the angle of the handle 6 is adjusted. The dial means 45a is a first plate 18b formed on the first segment 18a and a second plate 20b formed on the second segment 20a. The dial means 45a includes a series of serrated teeth 45b extending from a center on the plate 18b; a matching set of serrated teeth 45d is contained on the plate 20b, wherein reciprocal teeth 45d also radiate from a center as seen in FIG. 2. Hence, the operator can rotatably adjust plates 18b, 20b in order to angularly adjust the handle 6 relative to the pole support 24. The threaded stem and knob 45e fit through the opening 45f and engages the plates 18b and 20b in order to attach plates 18b and 20b together at the desired angle.

Additionally, FIG. 2 depicts the angle adjustment plate 38 which includes the bracket side 34 and the bracket side 36 with openings therein, and wherein the axle member 46 cooperates with the opening 48 on the wheel 40, and in this way the wheel 40 is connected to the angle adjustment plate 38 via the nut 49 threadedly engaging with the threads on the axle member 46.

FIG. 2 also depicts the tab member 30 as well as the lock nut 50. The tab member 30 is pivotly connected to the lock nut 50 via the wing nuts 52a, 52b. Also shown is the thrust bearing members 54 above the plate 38 and the thrust bearing members 56 below the plate 38 for 11 facilitating rotation and distributing loads. The double bearing members 54, 56 make it easy for the operator to make direction changes. The securing bolt 58 will be disposed through the opening 60 on the plate 38. The threads 62 will engage with internal threads (not seen in this view) within the pole support 24. Hence, in order to fasten the pole support 24 to the plate 38, the bolt 58 is threadedly engaged with the pole support 24. It should be noted that the tab member 30 has on its underside (not seen in this view) a pin that will engage with the apertures 42; therefore, in order to set the proper wheel 40 direction and orientation, the tab member 30 is pivoted upward, unlocking the pin; the tab member 30 is rotated to a new position; and, the tab member 30 is pivoted downward so that the pin engages another aperture.

Referring now to FIG. 3, a side view of the apparatus 2 seen in FIG. 1 will now be described. The clamp member 16 is engaging the handle 6 at the desired height, which in turn places the cutting head 4 at the desired height. In the most preferred embodiment, the angle of the cylinder member 22 to the indented portion I is approximately 45 degrees denoted by A. In the view of FIG. 3, the tab member 30 has been pivoted upward. As shown, the pin 66 is not engaged with the angle adjustment plate 38 so that the operator may rotate the wheel 40 in the desired direction, as per the teachings of this invention. Once the desired direction is chosen, the operator simply pivots the tab member 30 downward and engages the pin 66 with the desired aperture to give the proper wheel 40 direction orientation.

As an alternative to raising the height of the cutting head 4, the knob 26 is disengaged, the clamp member 16 is moved upward relative to the pole support 24, the knob 26 reset thereby adjusting the height of the cutting head 4. As noted earlier, the operator can also move the handle 6 within the indented portion I of the clamp member 16 either in or out, which will have an effect of raising or lowering the cutting head 4. Additionally, the operator can rotate handle 6 within the indented portion I of the clamp member 16 which in turn will rotate the inclination of the cutting head 4. As seen in FIG. 3, the cutting head 4, and in particular blade 14, is cutting the grass G in a perpendicular orientation.

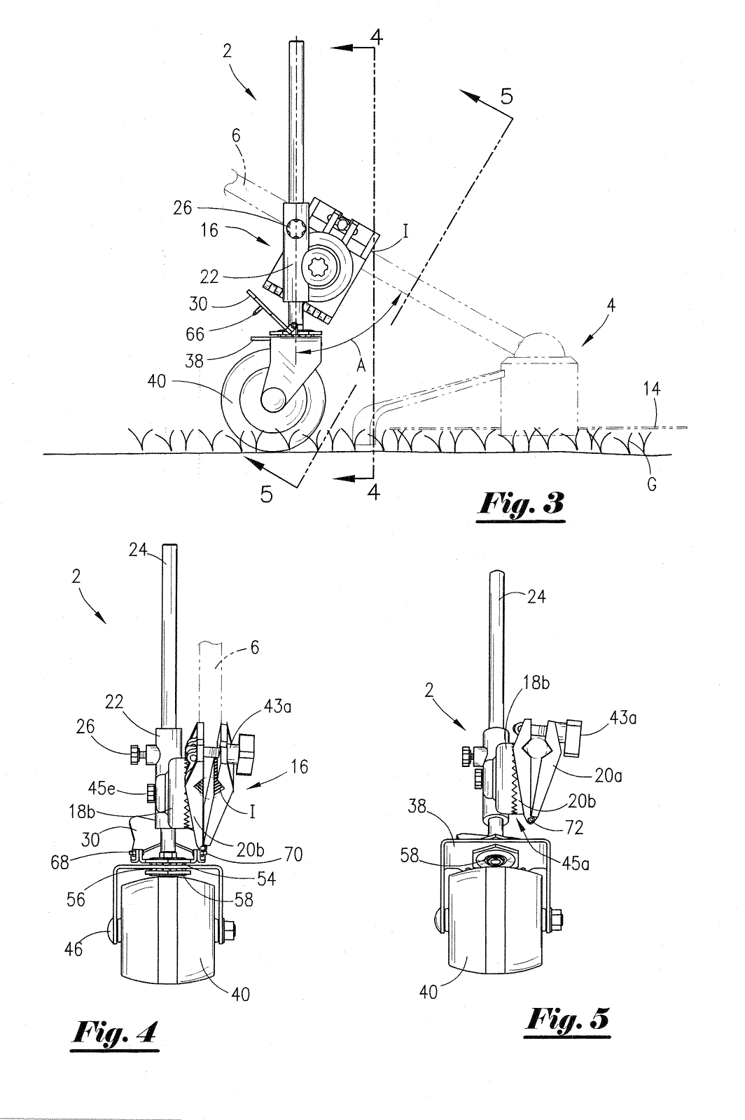

Referring now to FIG. 4, a partial front view of apparatus 2 taken along line 4-4 of FIG. 3 will now be described. FIG. 4 shows the pole support 24 fitted through the cylinder member 22. The knob 26 secures the pole support 24. The handle or shaft 6 is disposed through the clamp member 16 within the indentation I. The handle grasping halves are shown latched via latch means 43a, and knob and stem 45e is shown connecting the plate 18b and plate 20b together. Also, the securing bolt 58 is shown, along with the axle member 46. FIG. 4 also depicts the double thrust bearings 54, 56. The tab member 30 is shown, as well as the pivot points 68, 70 for pivoting the tab member 30.

FIG. 5 is a partial front view of the apparatus 2 taken along the line 5-5 of FIG. 3. The latch means 43a is shown in the latched position using the handle grasping halves. The handle grasping halves are connected at pivot point 72. FIG. 5 also depicts the securing bolt 58. The serrated teeth of the dial means 45a of the two plates 18b, 20b are also seen in FIG. 5.

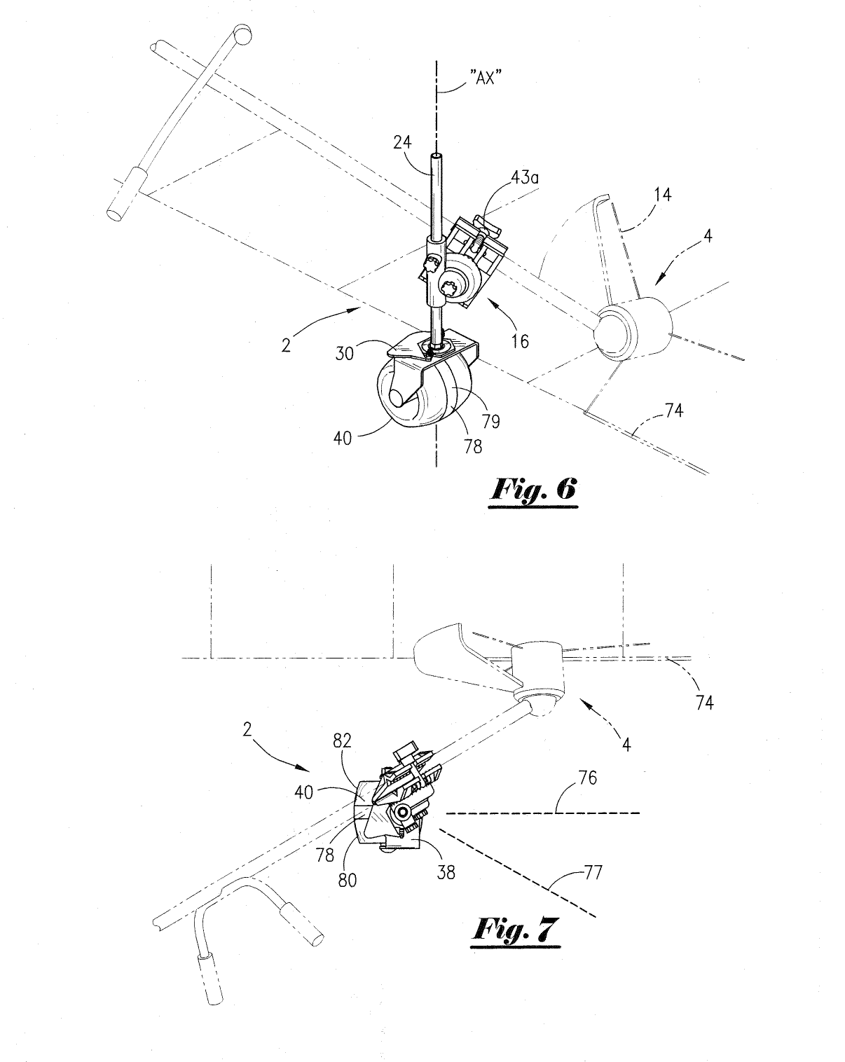

Referring now to FIG. 6, a perspective view of the apparatus 2 seen in FIG. 1 wherein the cutting head 4 has been tilted to a vertical position i.e. the cutting blade 14 is vertical relative to the ground, which as depicted is the sidewalk-grass interface 74. The operator accomplished rotating the cutting head 4 into the position shown in FIG. 6 by unlatching the latch means 43a, rotating the handle 6 to the desired position, latching the latch means 43a, and activating the power unit. Note that it may be desirable that the operator moves the clamp member 16 (relative to the pole support) up or down in order adjust the cutting head to the proper height. As per the teachings of the present invention, the operator can also adjust the wheel 40 direction relative to the clamp member 16 so that the operator can assume the proper position for operation of the cutting head 4. As mentioned earlier, the direction of the wheel 40 relative to the clamp member 16 is adjusted via the angle adjustment plate, and in particular, use of the pin on the tab member 30 to engage the proper aperture.

FIG. 7 is a top perspective view of the apparatus 2 seen in FIG. 6. As shown, the cutting head 4 is generally vertical to the sidewalk-grass interface 74. Also, the direction of the wheel 40 is denoted by the line 76. As per the teachings of the present disclosure, the direction of the wheel can be changed by readjusting the pin's engagement with the apertures within the angle adjustment plate 38, as previously described; for instance, the direction can be adjusted to the direction denoted by the line 77.

Additionally, FIG. 7 shows that the wheel 40 has a center cylindrical surface 78, a first elliptical surface 80 on one side, and a second elliptical surface 82 on the opposite side. The operator may change the direction of travel of the wheel 40 by tilting the wheel 40 on elliptical surface 80 (which will be a curved, circular path) and/or tilting onto elliptical surface 82 (which will also be a curved, circular path).

The center cylindrical surface 78 is configured to contact the ground surface. The surface 78 has a width, and wherein the surface 78 acts to reduce the friction between the wheel 40 and the ground surface. Also, as seen in FIG. 6, the pole support 24 has a longitudinal axis “AX” there through, and wherein the axis “AX” intersects the cylindrical surface 78 at the mid-way point 79 as seen in FIG. 6. The position of the axis “AX” relative to the cylinder surface 78 allows for easy and accurate rotation of the cutting head to the desired orientation.

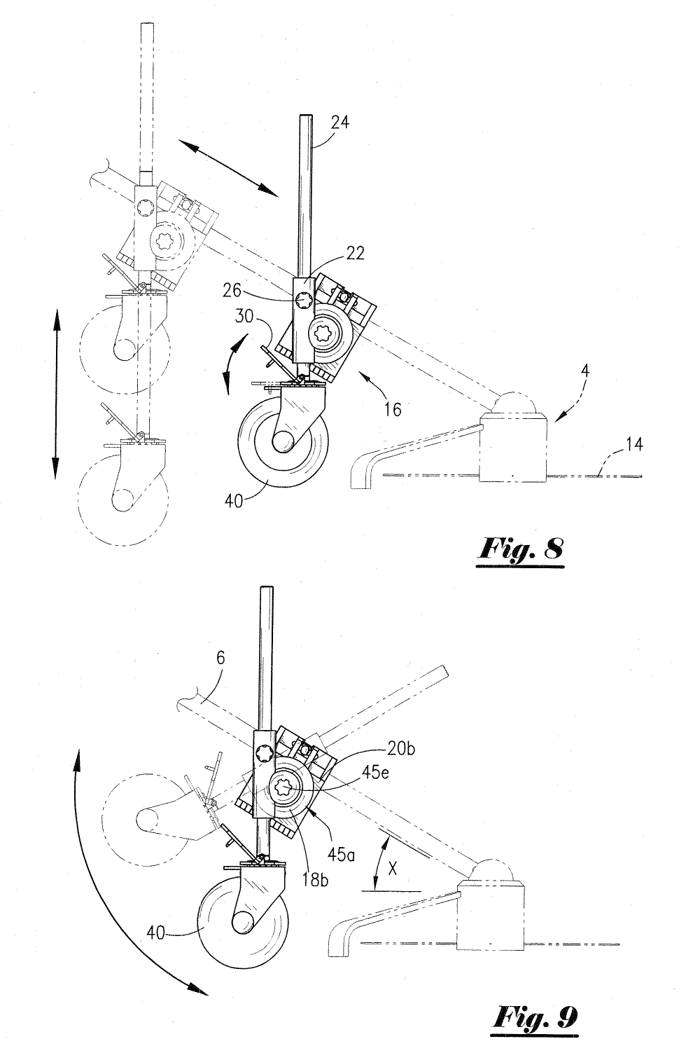

In FIG. 8, a perspective side view of the apparatus seen in FIG. 1 showing the clamp member 16 in different positions. FIG. 8 depicts the clamp member 16 (solid lines) in a first position. The phantom lines show clamp member 16 in a second position wherein the knob 26 has been released, and the clamp member 16 brought up the pole support 24, or alternatively, the clamp member 16 brought down the pole support 24. The position is selected by the specific circumstances of the cutting and the operator preferences.

FIG. 9 illustrates a perspective view of the apparatus seen in FIG. 1 depicting the wheel 40 being rotated in different positions by the dial means 45a. The dial means 45a has been rotated as per the teachings of this description. The phantom lines show where the operator, based on his unique conditions, may wish to adjust the handle 6 relative to the wheel 40. In order to adjust, the operator will back-off the knob 45e, rotates the dial face, engages the teeth in the new, desired position, and tightens the knob 45e i.e. the plates 18b and 20b have been rotated and the teeth then engage at the desired angle of the handle 6. As noted, the angle “X” would change accordingly.

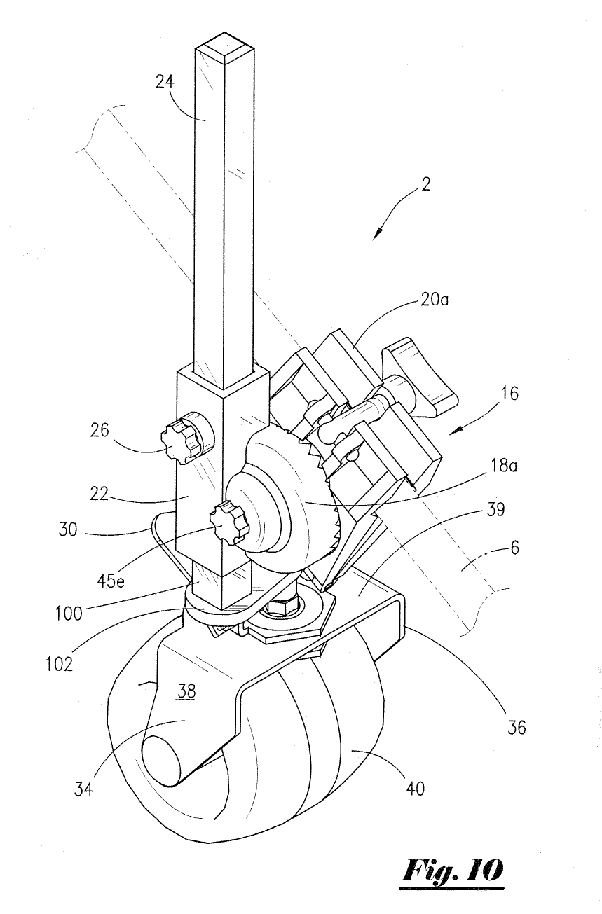

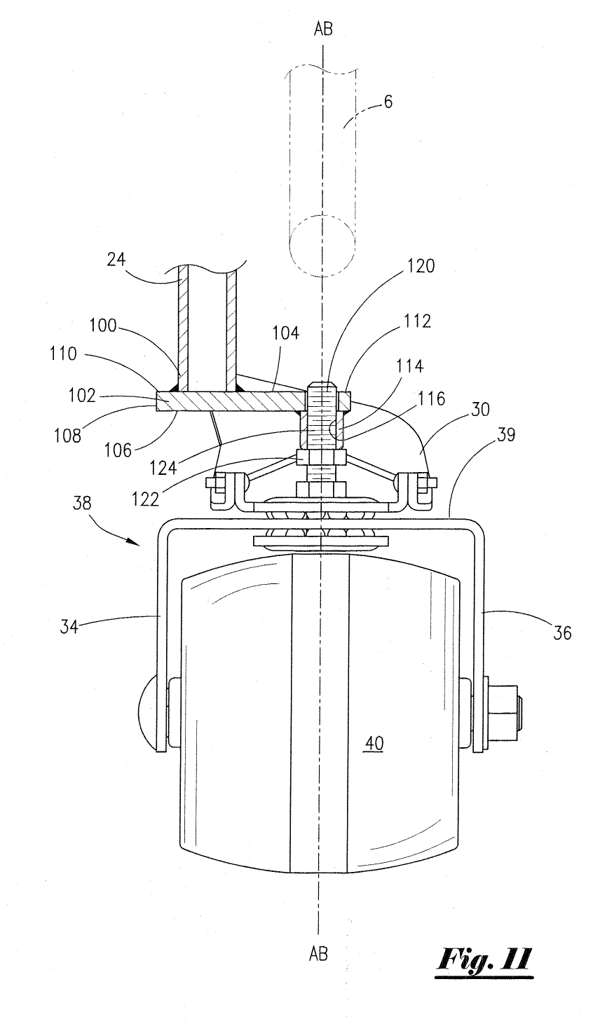

FIGS. 10 and 11 illustrate an alternative embodiment of the present invention. Pole support 24 has a square cross-section. Distal end 100 of pole support 24 is affixed to offset plate 102. Plate 102 has top surface 104, bottom surface 106, and side surface 108. Plate 102 has first end 110 and second end 112. Preferably, distal end 100 of pole support 24 is affixed to top surface 104 of plate 102. More preferably, distal end 100 of pole support 24 is affixed to top surface 104 of plate 102 at first end 110. Plate 102 may be made of metal such as iron, steel, or aluminum. If plate 102 and pole support 24 are each made of metal, distal end 100 of pole support 24 may be affixed to plate 102 by welding or preferably tack welding. Alternatively, pole support 24 and plate 102 could be made as an integral piece of metal or hardened plastic.

Again with reference to FIGS. 10 and 11, offset plate 102 may include extension 114 affixed to plate 102. Preferably, extension 114 is affixed to bottom surface 106 of plate 102 and is perpendicular thereto. More preferably, extension 114 is affixed to bottom surface 106 of plate 102 at second end 112 thereof. Bolt hole 116 may extend through plate 102 and extension 114 to provide a receptacle for securing bolt 58. Extension 114 may be made of metal such as iron, steel, or aluminum. If made of metal, extension 114 may be affixed to plate 102 by welding such as tack welding. Alternatively, plate 102 and extension 114 may be an integral piece of metal or hardened plastic.

With further reference to FIGS. 10 and 11, securing bolt 58 is positioned in and through bolt hole 116 in extension 114 and plate 102. Inner surface of bolt hole 116 may contain threads that mate with cooperating threads on securing bolt 58. Securing bolt 58 may be threadedly connected through bolt hole 116 with distal end 120 of securing bolt 58 extending up through bolt hole 116 on top surface 104 of plate 102. Locking nut 122 is secured to middle section 124 of securing bolt 58 and is wound down on extension 114 and tightened thereby further securing bolt 58 to plate 102. In this way, an operative connection is made between the caster means (i.e., the wheel assembly comprising wheel 40 and bracket sides 34, 36) and clamp member 16.

The alternative embodiment of the present invention shown in FIGS. 10 and 11 has a center axis of alignment designated as “AB” running through wheel 40 and shaft 6 of the trimmer. Offset plate 102 therefore acts to offset the alignment of wheel 40 from pole support 24 to align with shaft 6 of the cutting device. By aligning the center axis of wheel 40 with the center axis of shaft 6 of the cutting device, an improved balance is achieved making the operation of the cutting device easier and more user friendly.

Although the present invention has been described in terms of specific embodiments, it is anticipated that alterations and modifications thereof will no doubt become apparent to those skilled in the art. It is therefore intended that the following claims be interpreted as covering all such alterations and modifications as fall within the true spirit and scope of the invention.

What is claimed is:

1. An apparatus for attachment to a weed and grass trimmer comprising:
a clamp member including a pole-support member and a clamp assembly, said clamp assembly having two matching V-shaped halves, each of said halves with a proximal end and a distal end, said distal end of each of said halves being pivotally connected together, said clamp assembly containing an indented portion for engaging a shaft of said trimmer;
a pole support having a proximal end and a distal end, said pole-support operatively associated with said pole-support member, a portion of said pole support being encased within an elongated integral portion of said pole support member;
an attaching assembly associated with said clamp member, said attaching assembly including an adjustable knob and connected stem, said stem being configured to engage said pole support in order to slidably adjust said pole support relative to said clamp member;
an offset plate having a top surface, a bottom surface, and a side surface, said offset plate having a first end and a second end, said distal end of said pole support being affixed to said top surface of said offset plate at said first end thereof;
an angle adjustment plate operatively attached to said offset plate at said second end thereof, said angle adjustment plate having a bracket extending therefrom;
a wheel member operatively attached to said bracket, said wheel member having a first elongated elliptical surface extending to a cylindrical surface, said cylindrical surface extending to a second elongated elliptical surface, and said cylindrical surface contacts a ground surface in order to reduce the friction of said wheel member to said ground surface, said wheel member having a center axis in alignment with a center axis of said shaft of said trimmer;
means for orienting said angle adjustment plate to a proper orientation with respect to said wheel member, said means for orienting including a series of apertures in said angle adjustment plate;
a tab member operatively attached to said pole support for rotating said pole support to align with said orienting means; and
a locking means for locking said tab member in place relative to said angle adjustment plate, said locking means comprising a pin directly affixed to said tab member, wherein said pin is configured to engage a selected aperture of said series of apertures in said angle adjustment plate such that said wheel is prevented from swiveling with respect to said tab member but not prevented from rolling.

2. The apparatus according to claim 1 wherein the indented portion of said clamp assembly is at an angle between 30 degrees and 50 degrees relative to the pole support.

3. The apparatus according to claim 1 wherein said offset plate is substantially oval-shaped.

4. The apparatus according to claim 1 wherein said offset plate includes a threaded hole for threadedly receiving a bolt, said bolt operatively associating said offset plate to said angle adjustment plate.

5. The apparatus according to claim 4 wherein said offset plate includes an extension protruding from said bottom surface of said offset plate, said extension containing a threaded hole in alignment with said threaded hole in said offset plate, said threaded holes of said extension and offset plate threadedly receiving said bolt.

6. The apparatus according to claim 5 wherein said bolt is secured to said extension by a locking nut.

7. An apparatus for attachment to a weed and grass trimmer comprising:
a clamp member including a pole-support member, a dial means for rotating a shaft of said trimmer when said shaft is engaged with said clamp member so that an angle of said shaft is adjustable, and a clamp assembly having two matching V-shaped halves, each of said halves with a proximal end and a distal end, said distal end of each of said halves being pivotally connected together, said clamp assembly containing an indented portion for engaging said shaft of said trimmer;
a pole support having a proximal end and a distal end, said pole support operatively associated with said pole-support member, a portion of said pole support being encased within an elongated integral portion of said pole-support member;
an attaching assembly associated with said clamp member, said attaching assembly including an adjustable knob and connected stem, said stem being configured to engage said pole support in order to slidably adjust said pole support relative to said clamp member;
an offset plate having a top surface, a bottom surface, and a side surface, said offset plate having a first end and a second end, said distal end of said pole support being affixed to said top surface of said offset plate at said first end thereof;
an angle adjustment plate operatively attached to said offset plate at said second end thereof, said angle adjustment plate having a bracket extending therefrom;
a caster means including a wheel, said wheel being operatively attached to said bracket of said angle adjustment plate for rotatably moving the cutting head, said wheel including a first elongated elliptical surface extending to a cylindrical surface, said cylindrical surface extending to a second elongated elliptical surface, said wheel having a center axis in alignment with a center axis of said shaft of said trimmer;
means for orienting said angle adjustment plate to a proper orientation with respect to said caster means, said means for orienting including a series of apertures in said angle adjustment plate;
a tab member operatively attached to said pole support for rotating said pole support to align with said orienting means;
a locking means for locking said tab member in place relative to said angle adjustment plate, said locking means comprising a pin directly affixed to said tab member, wherein said pin is configured to engage a selected aperture of said series of apertures in said angle adjustment plate such that said wheel is prevented from swiveling with respect to said tab member but not prevented from rolling.

8. The apparatus of claim 7 wherein the dial means includes a first plate having serrated teeth disposed about a center of the first plate and a second plate having reciprocal serrated teeth disposed about a center of the second plate.

9. A method for cutting vegetation comprising the steps of:
(a) providing a cutting device, said device comprising: a cutting head; a shaft attached to said cutting head; a power unit attached to said shaft and supplying power to said cutting head; a clamp having disposed therein said shaft of said device, said clamp including a pole-support member and a clamp assembly, said clamp assembly having two matching V-shaped halves, each of said halves with a proximal end and a distal end, said distal end of each of said halves being pivotally connected together, said clamp assembly containing an indented portion for engaging said shaft of said cutting device; a pole having a proximal end and a distal end, said pole operatively associated with said pole-support member, said pole-support member including an elongated integral portion that encases a portion of said pole; an attaching assembly associated with said pole-support member, said attaching assembly including an adjustable knob and connected stem, said stem being configured to engage said pole in order to slidably adjust said pole relative to said pole-support member; an offset plate having a top surface, a bottom surface, and a side surface, said offset plate having a first end and a second end, said distal end of said pole being affixed to said top surface of said offset plate at said second end thereof; an angle adjustment plate operatively attached to said offset plate at said second end thereof, said angle adjustment plate having a bracket extending therefrom; a wheel operatively attached to said bracket, said wheel having a center axis in alignment with a center axis of said shaft of said cutting device; a series of apertures for orienting said angle adjustment plate to a proper orientation; a tab operatively attached to said pole for rotating said pole for selecting the aperture; a locking means for locking said tab in place relative to said angle adjustment plate, said locking means comprising a pin directly affixed to said tab, wherein said pin is configured to engage a selected aperture of said series of apertures in said angle adjustment plate such that said wheel is prevented from swiveling with respect to said tab but not prevent from rolling;
(b) adjusting the height of the clamp relative to the pole so that the height of the cutting head is changed;
(c) energizing the power unit;
(d) rotating the cutting head; and
(e) cutting vegetation with the cutting head.

10. The method of claim 9 further comprising the steps of: (f) terminating a power to said power unit thereby de-energizing the power unit; and (g) adjusting the orientation of said wheel, wherein the orientation of said wheel is adjusted by engaging said tab with a selected aperture so that the direction of said wheel is adjusted.
